(19) United States
(12) Patent Application Publication
(10) Pub. No.: US 2017/0258663 A1
(43) Pub. Date: Sep. 14, 2017

(54) PROGRESSIVE RESISTANCE REHABILITATION SWALLOWING APPARATUS AND METHOD OF USE

(71) Applicants: Page Parker, Altamonte Springs, FL (US); Jolie Parker, Altamonte Springs, FL (US)

(72) Inventors: Page Parker, Altamonte Springs, FL (US); Jolie Parker, Altamonte Springs, FL (US)

(21) Appl. No.: 15/064,140

(22) Filed: Mar. 8, 2016

(51) Int. Cl. A61H 1/02

(52) U.S. Cl. CPC A61H 1/02; A61H 2201/1269; A61H 2201/1607; A61H 2201/1619; A61H 2201/0153

(57) ABSTRACT

Embodiments described herein include a substantially elongated and curvilinear polycarbonate mechanism with a chin and chest pad that may be releasably or permanently secured to the mechanism using at least a set screw or glue. The polycarbonate mechanism is flexible, durable and allows a user to customize chin elevation and exercise the chin, mouth, and throat to combat dysphagia and improve speech, voice, posture, and jaw alignment. Furthermore, the apparatus may be used with a variety of throat, jaw, and mouth exercises to isolate specific muscle groups and increase rehabilitation efficiency.

### FIELD

This written description relates to a progressive resistance rehabilitative apparatus for strengthening and improving jaw, facial, and deglutition (swallowing) muscles, and in particular, an apparatus and method for improving swallowing muscles and jaw stability utilizing portable progressive resistance technology.

### BACKGROUND

Research has shown that over 85% of the world's population will experience neck, mouth, or swallowing difficulties sometime in their lives. Specifically, the difficulties associated with swallowing known as dysphagia are most commonly found amongst the elderly where stroke and Alzheimer's condition are most prevalent. One method of treating these disorders is through speech therapy by using techniques that target neuromuscular soft tissues. Conversely, if these swallowing disorders continue to exacerbate, they may lead to aspiration pneumonia and could lead to asphyxiation.

Further, swallowing and jaw stability are complex neuromuscular movements which involve the skeletal muscles of the tongue, smooth muscles of pharynx and esophagus, and. neurological coordination.

There are currently several references associated with swallowing exercises and throat/neck line toning such as U.S. Pat. No. 5,213,553, U.S. Pat. No. 7,798,149, U.S. Pat. No 1,543,346 and WO. No. 2005021103. However, these references fail to provide a full range of motion to the jaw and throat muscles and limit the user's starting positions to a substantially level chin setting. The results of this limited mobility minimizes effects to the oral and pharyngeal phases of swallowing, speech/voice articulation, resonance (hyper/hypo nasality), and nerve functions.

### SUMMARY OF THE INVENTION

Embodiments described herein include a progressive resistance rehabilitation swallowing apparatus for use in a variety of settings. Some embodiments include a substantially elongated and curvilinear polycarbonate mechanism with releasably, securable chest and chin pads that may be affixed using at least a set screw, Velcro®, or mounting tape and glue and disposable, removable chin pad covers (adhesive) or plastic/vinyl.

The advantages of some embodiments include the ability to isolate specific suprahyoid and submental jaw and facial muscles, and increase range and versatility from variations currently found in the market. Ancillary benefits include increased mobility to the longus capitis and longus colli neck muscles, cervical spine stabilization, improvement to jaw alignment, and posture control.

Some embodiments may be further used in conjunction with exercise techniques such as the Chin Tuck Against Resistance (CTAR), Effortful Swallow Against Resistance (ESAR), and Jaw Opening Against Resistance (JOAR) to isolate specific muscle groups in the jaw, mouth, and throat. Other aspects, advantages, and novel features of these embodiments will become apparent from the following detailed description in conjunction with the drawings.

### BRIEF DESCRIPTION OF THE DRAWINGS

A more complete understanding of the embodiments described herein, and the attendant advantages and features thereof, will be more readily understood by reference to the following detailed description when considered in conjunction with the accompanying drawings wherein:

FIG. 1 is a perspective view of a progressive resistance rehabilitation swallowing apparatus (i.e., static position);

FIG. 2 is an alternate of the apparatus; and

FIG. 3 is a further alternate view of the apparatus while being operated (i.e., non-static).

### DETAILED DESCRIPTION

Some embodiments include a progressive resistance rehabilitation swallowing apparatus. Some embodimentys provide variable jaw positioning and are designed to combat the swallowing disorder dysphagia. Specifically, the some embodiments isolate the suprahyoid muscles below the chin such as the geniohyoid, stylohyoid, mylohyoid, and digastric (anterior/posterior belly). These suprahyoid muscles assist in swallowing, speaking, elevating the tongue, and reinforcing the base of the mouth.

The embodiments further target the sternocleidomastoid (SCM) muscles which are primarily used to rotate the head, laterally flex the neck, and act as an accessory muscle to the inspiration and scalene muscles. These SCM, “flexor muscles” may further improve posture, jaw alignment, and swallowing mechanics. In addition, the current embodiment may be used with the following exercises to provide increased muscle mobility and strength.

Chin Tuck Against Resistance (CTAR): Begin by placing the apparatus under the chin at an optimal chin angle. Then apply a downward force onto the apparatus until the “tucked chin position” is achieved. This isometric and isotonic movement isolates the suprahyoid and submental muscles in the base of the tongue which is responsible for swallowing, speech articulation and stimulates the V, VII, IX, X, XI cranial nerves.

Jaw Opening Against Resistance (JOAR): Begin by placing the apparatus under the chin at an optimal chin angle. Then apply a downward force onto the apparatus until the chin is approximately level with the shoulders. The user then opens and closes the mouth isolating the genioglossus, hyoglossus, styloglossus, palatoglossus, superior/interior longitudinal, sternohyomastoid, masseter, pterygoids, temporalis, digastric, mylohyoid, and geniohyoid jaw and tongue muscles. The apparatus in conjunction with the exercise further stimulates the V, VII IX, X, XI, and XII cranial muscles for improved facial sensation, chewing, resonance, speech, and swallowing functions.

Effortful Swallow Against Resistance (ESAR): Begin by placing the apparatus under the chin at an optimal chin angle. Then apply a downward force onto the apparatus until the “tucked chin position” is achieved. While holding the “tucked chin position,” the user then exacerbates the squeezing and holding position associated with a “swallow” to strengthen the genioglossus, hyoglossus, styloglossus, palatoglossus, superior/interior longitudinal tongue muscles and further stimulating the V, VII, IX, X, XI, and/or XII cranial muscles for improved nerve function/sensation associated with chewing, swallowing, voice, resonance, and speech.

Oral Motor Exercises with CTAR: While holding the CTAR exercise, perform lingual and labial exercises such as: lingual press against the hard palate, lateral lingual presses into the cheeks, lingual circles behind the lips, lingual up and down in the cheek, lingual sweep along the outside of upper and lower teeth/gurus, base of tongue retraction, lingual clicking, labial presses, labial spreading (smile), and labial smacks. The purpose of these exercises is to strengthen the muscles in the tongue, lips, and base of the tongue and improve coordination of these motor functions, for improved swallowing, swallowing pressures, to decrease oral and pharyngeal residue after the swallow, speech articulation, and/or to stimulate Cranial Nerve(s) V, VII, IX, X, XI, and/or XII for improved nerve function/sensation for chewing, swallowing, voice, resonance, and speech.

Base of Tongue Retraction Exercises with CTAR and JOAR: While holding the CTAR exercise, say words or sentences that contain a lot of velar sounds /g/, /k/, and /ng/ which cause the base of the tongue to etract when pronounced. When saying these words or sentences, the jaw opens against the resistance of the device. The purpose of these exercises is to strengthen the muscles in the base of the tongue and improve coordination of these motor functions, for improved swallowing, swallowing pressures, to decrease oral and pharyngeal residue after the swallow, speech articulation, resonance, and/or to stimulate Cranial Nerve(s) V, VII, IX, X, XI, and/or XII for improved nerve function/sensation for chewing, swallowing, voice, resonance, and speech.

Vocal Cord. Adduction Exercises with CTAR: The standard way of doing VCA exercises is by pressing on the arms of a chair while phonating a long sustained “ahh” or phonating “ah” with a hard glottal attack in order to create a mild strain which automatically causes the vocal cords to press together. By using the ISO-PLUS with CTAR to create the strain, instead of pressing on the arms of a chair, it makes this exercise less strenuous and makes it possible to do this exercise with only one arm if needed for patients with physical limitations. It also adds the benefit of increased Cranial Nerve stimulation by holding the CTAR position. The purpose of this exercise is to strengthen the muscles that close the vocal cords and improve coordination of these n r functions, for improved vocal quality and volume, and improved airway protection during the swallow, and/or to stimulate Cranial Nerve(s) V, VII, IX, X, XI, and/or XII for improved nerve function/sensation for chewing, swallowing, voice, resonance, and speech.

Laryngeal Elevation Exercises with CTAR: While holding the CTAR exercise position, sing a musical scale up to the highest note you can reach and hold that note as long as possible, or repeat sounds or words using the highest pitch voice you can. This exercise is commonly done to improve laryngeal elevation for voice or swallowing, but it is done without a device or any resistance or CTAR component. By adding the resistance device to this exercise, it intensifies the exercise and increases stimulation to the Cranial Nerves. The purpose of this exercise is to strengthen the muscles that elevate the larynx and improve coordination of these motor functions, for improved swallow function and safety, improved vocal pitch range, and/or to stimulate Cranial Nerve(s) V, VII, IX, X, XI, and/or XII for improved nerve function/sensation for chewing, swallowing, voice, resonance, and speech.

Swallowing Exercises with CTAR: Exercises which are commonly performed to improve swallow function and safety can be done while holding the CTAR exercise with the ISO-PLUS to intensify the following exercises: Mendelsohn Maneuver, Masako's Technique, Showa's Maneuver, Supraglottic Swallow, and Super Supraglottic Swallow. The purpose of these exercises is to strengthen the muscles in the base of the tongue, the laryngeal elevators, and the vocal cord adductors, and improve coordination of these motor functions for improved swallowing, swallow safety, swallowing pressures, to decrease oral and pharyngeal residue after the swallow, speech articulation, resonance, and/or to stimulate Cranial Nerve(s) V, VII, IX, X, XI, and/or XII for improved nerve function/sensation for chewing, swallowing, voice, resonance, and speech.

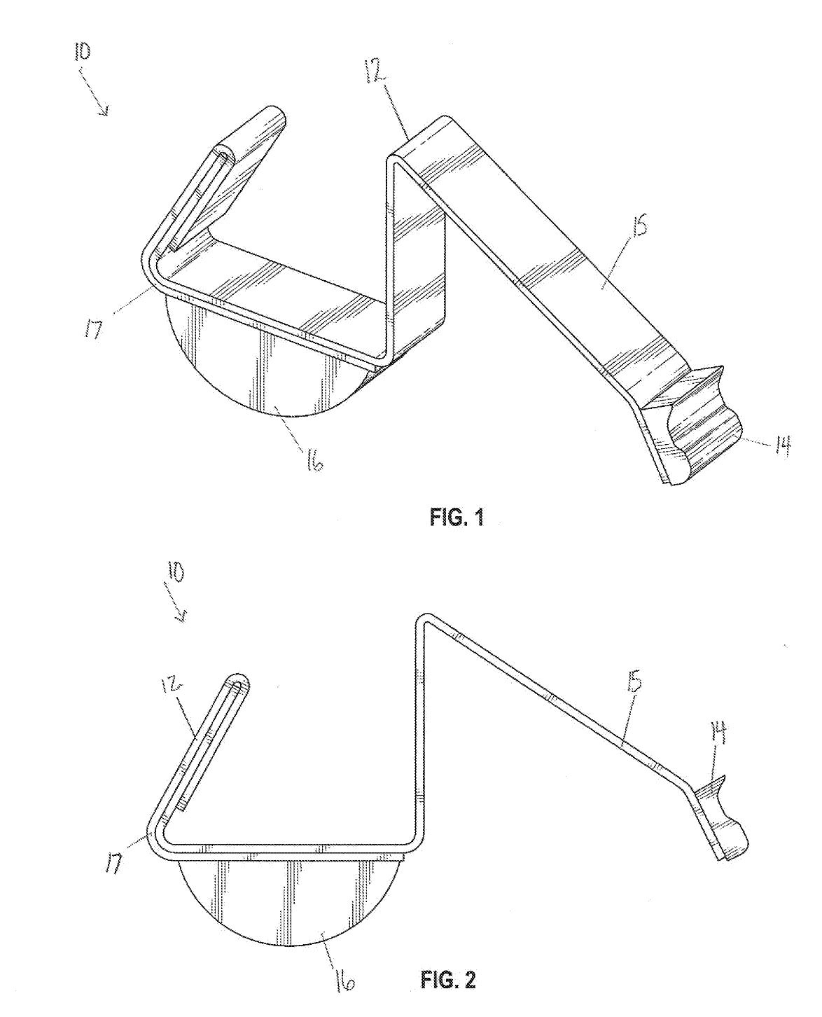

Referring now to the drawings wherein like reference numerals designate identical or corresponding parts throughout the views, there is shown in FIG. 1 the progressive resistance rehabilitation apparatus placed in a “static position) (hereinafter known as “apparatus”) 10. The apparatus 10 is a rehabilitation mechanism that enables a user to place their chin against the apparatus and press downward to provide exercise and strength building techniques to at least the use's tongue, neck, and chin. The apparatus 10 is comprised of a progressive resistance rehabilitation mechanism 12 that is durable, flexible, and may be biased by the user when conducting the plethora of exercises listed above. The mechanism 12 is lightweight, portable and may be operated by the user with or without hands allowing the user's suprahyoid muscles to fatigue before the arm muscles fatigue from having to use both arms to hold the apparatus 10 in position. Furthermore, the mechanism 12 may at least contain a releasably secured chin pad 14 at a first end 15, and chest pad 16 at the second end 17. The chin pad 14 is contoured to dimensions of a mandible (lower jaw) and is designed for the user to efficiently maximize the resistance exercises of apparatus 10 while preventing brusing or irritation to the user's chin. Furthermore, the chin pad 14 may be comprised of a pliable material such as foam for additional comfort and contouring and may be covered by disposable covers to avoid cross contamination as its exchanged between user's or patients. The entire apparatus 10 may be cleaned with alcohol or a suitbale medical disinfectants.

The chest pad 16 is located at the second end 17 and releasbly affixed to the apparatus 10 using a securing means such as a screw, Velcro®, or tape and glue and provides comfort to the user while being secured against the user's body to provide additional stability while being operated.

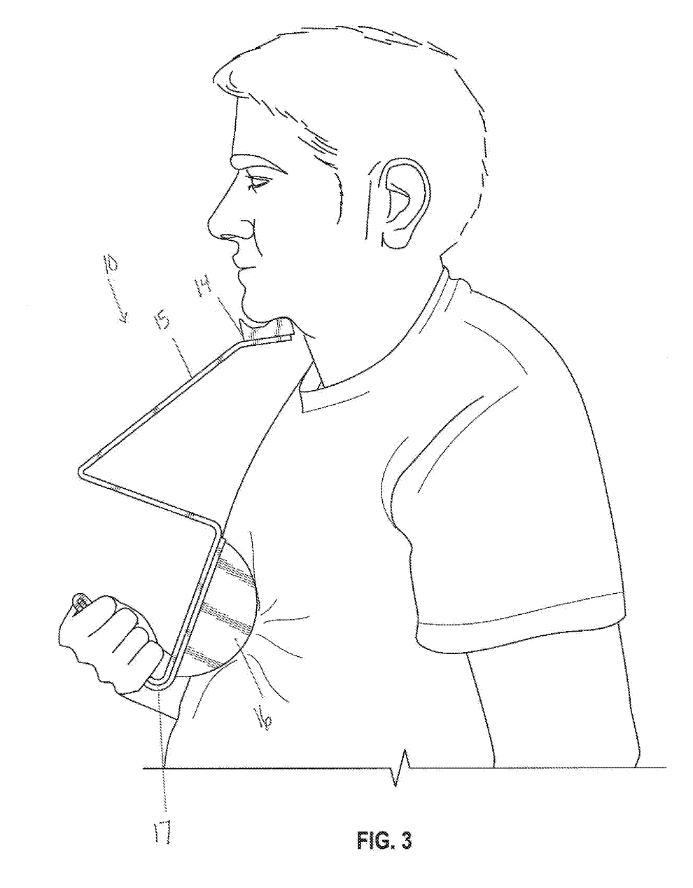

Shown in FIG. 2 is a further view of the apparatus 10 in the static position not in use. Shown in FIG. 3 is a view of the apparatus in use (non-static) with a user's chin placed against chin pad 14 and chest pad 16 placed against the user's body which provides support the apparatus. The chest pad 16 enables the operator to securely fit the apparatus 10 against the body part while the pliable material may mold to the contours of the user's body without it sliding out of position or uncomfortably interfering with the user.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the following claims.

What is claimed is:

1. A progressive resistance rehabilitation apparatus, comprising:
a progressive resistance rehabilitation mechanism, the progressive resistance rehabilitation mechanism configured to provide coiled resistance at a first end of the mechanism to at least a chin, tongue, and neck of a user when a downward compression force is applied.
a chin pad, the chin pad dimensioned to be releasbly or permanently secured between the mechanism and the user's chin and configured to provide a protective cushioning while in use; and
a chest pad, the chest pad releasably secured to the mechanism at the second end and configured to provide a stabilizing force to the mechanism while in use when positioned against a body part of the user.

2. The apparatus of claim 1, wherein the first end of the progressive resistance rehabilitation mechanism further includes an elongated and coiled configuration to provide a coiled resistance against the user's chin.

3. The mechanism of claim 2, wherein the progressive resistance rehabilitationthanism is comprised of a flexible and durable material such as a polycarbonate, plastic, polymer, or rubber to enable a coiled resistive force against a user's chin while in use.

4. The apparatus of claim 1, wherein the chin pad further includes an elongated configuration with a hollow region to allow the user to slide onto the first end of the mechanism.

5. The apparatus of claim 4, wherein the chin pad further includes a compression foam to enable a contoured shape to the user's chin while in use.

6. The apparatus of claim 5, wherein the chin pad further includes at least one set screw attachment means.

7. The apparatus of claim 1, wherein the second end further includes a handle portion to enable a user to grip the mechanism with one hand while in use.

8. The apparatus of claim 7, wherein the chest pad is comprised of a pliable material such as a polydisperse or foam to allow the user to contour the chest pad when positioned against the body part of the user.

9. The apparatus of claim 8, wherein the chest pad is releasably attached to the second end of the mechanism is glued on.

10. A progressive resistance rehabilitative apparatus, comprising:
a progressive resistance rehabilitation mechanism, the progressive resistance rehabilitative mechanism having a first and second end; the first end including a substantially coiled configured to provide a resistive force to at least a user's chin, neck, and tongue muscles when compressed by a user's head.
a chin pad, the chin pad configured to be removeably or permanently affixed onto the first end of the progressive resistance rehabilitative mechanism to provide cushioning to the user's chin while in use; and
a chest pad, the chest pad further including a substantially rectangular configuration and releasably or permanently attached at the second end of the mechanism to provide a stabilizing force while positioned against a user's chest.

11. The apparatus of claim 10, wherein the progressive resistance rehabilitative mechanism is comprised of a flexible material such as a polycarbonate, rubber, plastic, or polymer to provide a coiled resistive force to the user's head when compressed downward.

12. The apparatus of claim 11, wherein the second end of the mechanism further includes a handle to enable a user to releasably grip with a single hand with a neck support strap.

13. The apparatus of claim 10, wherein the chin pad is comprised of memory foam material to contour to the user's chin while in use.

14. The apparatus of claim 13, wherein the chin pad further includes at least one set screw or glue.

15. The apparatus of claim 10, wherein the chest pad is comprised of a pliable material to releasably contour while depressed against the user's chest.

16. A method of operating a progressive resistance rehabilitation apparatus, comprising:
positioning the first end of the apparatus under a user's chin, and the second end against a user's chest;
placing a downward force onto the first end of the apparatus to enable resistance to at least a user's chin, neck, and tongue muscles; and adjusting an angle between the apparatus and the user's jaw; and
removing the downward force placed on a chin pad by a user's head and return the first end to a rest position.
